(19) United States
(12) Patent Application Publication
(10) Pub. No.: US 2012/0009348 A1
(43) Pub. Date: Jan. 12, 2012

(54) METHOD AND APPARATUS FOR CONTINUOUS THIN FILM DEPOSITION PROCESS IN VACUUM

(76) Inventors: Shenjiang XIA, Hangzhou (CN); Jiong JIN, Hangzhou (CN); Zhiqiang ZHU, Hangzhou (CN)

(21) Appl. No.: 13/175,971

(22) Filed: Jul. 5, 2011

Related U.S. Application Data
(63) Continuation of application No. PCT/CN2009/073184, filed on Aug. 11, 2009.

(30) Foreign Application Priority Data
Jan. 12, 2009 (CN) 200910095388.7

(51) Int. Cl. B05D 1/00; B05C 13/00; B05C 11/00; B05C 9/08

(52) U.S. Cl. 427/294; 118/696

(57) ABSTRACT

A method and apparatus for continuously depositing thin film on substrate in vacuum, the method including the following steps: maintaining the degree of vacuum in the vacuum deposition chamber by disposing at least one inlet vacuum pre-evacuating chamber at the inlet of the vacuum deposition chamber and disposing at least one outlet vacuum protection chamber at the outlet of the vacuum deposition chamber; connecting each inlet vacuum pre-evacuating chamber, the vacuum deposition chamber and each outlet vacuum protection chamber by a slit; adjusting the transportation speed of the substrate to shorten the distance between two adjacent substrates before arriving at the deposition device and to enlarge the distance between two adjacent substrates after the substrate left the vacuum deposition chamber, thereby realizing the continuous film deposition process and improving significantly the efficiency of utilizing raw materials.

### CROSS-REFERENCE TO RELATED APPLICATIONS

This application is a continuation of International Patent Application No. PCT/CN2009/073184, with an international filing date of Aug. 11, 2009, designating the United States, now pending, and further claims priority benefits to Chinese Patent Application No. 200910095388.7, filed Jan. 12, 2009. The contents of all of the aforementioned applications, including any intervening amendments thereto, are incorporated herein by reference.

### BACKGROUND OF THE INVENTION

1. Field of the Invention

The invention relates to vacuum film deposition technology, and more particularly, to a method and apparatus for continuous film deposition process in vacuum.

2. Description of the Related Art

The vacuum film deposition refers to the deposition of nanometer-sized and micron-sized metal, non-metal and semiconductor on the surface of substrate as a function layer by using vacuum film deposition technology at a certain vacuum degree. The current available vacuum film deposition technology includes chemical vapor deposition, vacuum evaporation, sputtering, organometallic vapor deposition, epitaxial film vacuum deposition, chemical vapor transfer deposition, sublimation deposition, close-spaced sublimation deposition and so on. The film thus obtained in a vacuum has been widely used in semiconductor industry, electronic industry, solar energy industry, and decoration industry. In order to accomplish the industrialization of film deposition technology, a series of continuous vacuum film deposition production line, such as sputtering production line, chemical vapor deposition production line in a moderate to high vacuum degree, has been developed. The successful development of these production lines has given an opportunity for the commercial application of vacuum film deposition technology. However, in the operation of these production lines, when one substrate is in vacuum deposition chamber for film deposition, the following substrate should be in the pre-vacuum chamber, and the substrate afterwards this substrate should be in the outside atmosphere air. After the vacuum degree in the pre-vacuum chamber is pumped down to the same as that in the vacuum deposition chamber, the substrate in the pre-vacuum chamber is allowed to be conveyed to the vacuum deposition chamber through a load-lock valve. After that, the substrate in the outside atmosphere air is allowed to enter the pre-vacuum chamber through a load-lock valve. As a result, productivity of the production line is relatively low. On the other hand, because the opening space between adjacent substrates is large enough, one is in the vacuum deposition chamber, the other in pre-vacuum chamber, so that the film deposition in the vacuum deposition chamber cannot be carried out continuously. Otherwise, there will be a large amount of waste for sputtering target or chemical materials.

Due to small size of the slit, pressure unbalance on both sides of glass substrate occurs under vacuum pumping in the inlet vacuum pre-evacuating chamber, further leading to the fluttering of the glass substrate in conveying. In addition, outside atmosphere air can still get into the vacuum deposition chamber through slit valves to reduce the vacuum degree of the vacuum deposition chamber and increase the oxygen concentration in the vacuum deposition chamber, even when the vacuum pumps in the inlet vacuum pre-evacuating chamber are operated continuously. It is still a large chance for the atmosphere air to enter into the vacuum deposition chamber through the slit passages.

### SUMMARY OF THE INVENTION

The technique problem that this invention is used to solve is: provide a continuous vacuum film vacuum deposition method and apparatus to ensure that the vacuum degree in vacuum deposition chamber does not change as substrates are continuously conveyed into the vacuum deposition chamber through inlet vacuum pre-evacuating chamber from outside atmosphere air and out of the vacuum deposition chamber into outside atmosphere air through outlet vacuum protection chamber. As a result, the substrates can enter the vacuum deposition chamber for vacuum film deposition and leave the vacuum deposition chamber after film deposition continuously, enhancing the productivity of vacuum film deposition production line.

Another technique problem that this invention is used to solve is: to shorten opening distance between two adjacent substrates by varying the speed of conveying substrates under constant vacuum degree in the vacuum deposition chamber. The opening distance between two adjacent substrates on the conveyer is shortened to be less than 1 cm before the substrates reach the film deposition device in the vacuum deposition chamber, maximizing the utilization of raw materials while the film deposition is carried out continuously.

In order to solve the above-described problems, the following technical solutions are adopted in this invention:

A method for continuously depositing thin film in vacuum, comprising the following steps:

A) maintaining the degree of vacuum in the inlet vacuum pre-evacuating chamber and the outlet vacuum protection chamber locating at both ends of vacuum deposition chamber is the same as that in the vacuum deposition chamber to ensure that the vacuum degree in the vacuum deposition chamber keeps unchanged by disposing at least one level of inlet vacuum pre-evacuating chamber at the inlet of the vacuum deposition chamber and at least one level of outlet vacuum protection chamber at the outlet of the vacuum deposition chamber;

B) connecting each level of inlet vacuum pre-evacuating chamber, vacuum deposition chamber and each level of outlet vacuum protection chamber by slits and sealing with valves located in slits, the valves at the inlet of vacuum deposition chamber are inlet valves, while the valves at the outlet of vacuum deposition chamber are outlet valves, substrates enter each chamber through slits, and the valves are opened when the substrate is passing and is closed after the substrate has passed;

C) conveying the substrates from the outside atmosphere air through the inlet vacuum pre-evacuating chamber to the vacuum deposition chamber for film deposition and conveying the substrates through the outlet vacuum protection chamber to the outside atmosphere air by the substrates at a certain speed and interval;

D) keeping at least one inlet valve and one outlet valve closed when the substrate is entering into the inlet vacuum pre-evacuating chamber and is leaving the outlet vacuum protection chamber, to keep the vacuum degree in the vacuum deposition chamber unchanged.

Further comprising the following step:

E) adjusting the conveying speed of substrates in each level of inlet vacuum pre-evacuating chamber, vacuum deposition chamber and each level of outlet vacuum protection chamber to shorten the distance between two adjacent substrates before they arriving at the film deposition device in the vacuum deposition chamber, and to enlarge the distance between two adjacent substrates after they left the vacuum deposition chamber.

The step E further comprising the following step: shortening the distance between two adjacent substrates to be less than 1 cm before they arriving the film deposition device in the vacuum deposition chamber.

The step E further comprising the following step: operating substrates conveys in the inlet vacuum pre-evacuating chamber, vacuum deposition chamber and outlet vacuum protection chamber independently, and controlling the substrates conveying speed by adjusting the conveying speed of corresponding conveyer.

The step E further comprising the following step: keeping the conveying speed of substrates constant in vacuum deposition chamber, installing a catch-up zone at the inlet of vacuum deposition chamber, and speeding up the movement of substrate in the inlet vacuum pre-evacuating chamber to catch up with its preceding substrate in catch-up zone; installing a separate zone at the outlet of vacuum deposition chamber, and speeding up the movement of substrate in the outlet vacuum protection chamber to separate from its following substrate in the separate zone.

A continuous film vacuum deposition apparatus comprising: a vacuum deposition chamber having a film deposition device, an inlet and a outlet; a conveyer having transmission belt and wheels; at least one level of inlet vacuum pre-evacuating chamber having a vacuum pump; at least one level of outlet vacuum protection chamber having a vacuum pump; slits; valves having inlet valves and outlet valves; and a control device; wherein the vacuum deposition chamber is used to deposit film on substrates; the conveyer is used to convey substrates from outside atmosphere air into the vacuum deposition chamber for film deposition through the inlet vacuum pre-evacuating chamber and from the vacuum deposition chamber into outside atmosphere air through the outlet vacuum protection chamber at a certain speed and interval; the inlet vacuum pre-evacuating chamber is connected with the inlet of vacuum deposition chamber; the outlet vacuum protection chamber is connected with the outlet of vacuum deposition chamber; the slits are located between the inlet vacuum pre-evacuating chamber, the vacuum deposition chamber and the outlet vacuum protection chamber, and are used for connection of chambers and movement of substrates; the valves are located at the position of each slit and are used for sealing chambers, the valves which located at the inlet of vacuum deposition chamber are inlet valves, while the valves which located at the outlet of vacuum deposition chamber are outlet valves; the valves are opened when the substrate is passing and closed after the substrate has passed; at least one of the inlet valves and one of the outlet valves are closed when the substrate is entering into the inlet vacuum pre-evacuating chamber and is leaving the outlet vacuum protection chamber; and the control device is connected with the valves and is used to control opening and closing of valves.

Further: substrate conveyers at each inlet vacuum pre-evacuating chamber, vacuum deposition chamber and outlet vacuum protection chamber are operated independently, each conveyer is connected by its own stepping motor and the substrate conveying speed is controlled by stepping motor, the distance between two adjacent substrates is shortened before arriving at the film deposition device in vacuum deposition chamber and enlarged when the film-deposited substrates are leaving the vacuum deposition chamber.

The substrates are arranged continuously in vacuum deposition chamber, and the-distance between two adjacent substrates is less than 1 cm.

Preferred: the inlet vacuum pre-evacuating chamber and the outlet vacuum protection chamber have two levels, respectively, the first level of the inlet vacuum pre-evacuating chamber is connected with outside atmosphere air and the second level of the inlet vacuum pre-evacuating chamber is connected with the inlet of vacuum deposition chamber. The first level of the outlet vacuum protection chamber is connected with outside atmosphere air and the second level of the outlet vacuum protection chamber is connected with the outlet of vacuum deposition chamber. Once the inlet valve of the first level of the inlet vacuum pre-evacuating chamber connecting with outside atmosphere air is opened for substrate to pass through, the inlet valve between two levels of inlet vacuum pre-evacuating chambers is in off-state. Once the outlet valve of the first level of the outlet vacuum protection chamber connecting with outside atmosphere air is opened for substrate to pass through, the outlet valve between two levels of the outlet vacuum protection chambers is in off-state.

When the above technical solutions are adopted: the vacuum film deposition method and apparatus in this invention is to convey substrates which are arranged at a certain opening distance between adjacent substrates from outside atmosphere air to vacuum deposition chamber for film deposition. The inlet and outlet valves connecting with outside atmosphere air are opened as the substrate is passing, and closed as substrates has passed. By varying the conveying speed of the substrate in the inlet vacuum pre-evacuating chamber and outlet vacuum protection chamber, the off-state time of the inlet and outlet valves connecting with outside atmosphere air is maximized to ensure that the vacuum degree in vacuum deposition chamber does not change as substrates are continuously conveyed into the vacuum deposition chamber through inlet vacuum pre-evacuating chamber from outside atmosphere air and out of the vacuum deposition chamber into outside atmosphere air through outlet vacuum protection chamber. Eventually, the thin film deposition on substrates can be operated continuously and material utilization is improved significantly by varying the conveying speed of substrates to shorten the opening distance between adjacent substrates in vacuum deposition chamber.

### BRIEF DESCRIPTION OF THE DRAWINGS

A detailed description of accompanying drawings will be provided below:

FIG. 1A is the longitudinal section view of continuous vacuum film deposition apparatus;

FIG. 2B is another longitudinal section view of continuous vacuum film deposition apparatus;

FIGS. 2A-2F are illustration views showing a process demonstrating the change of opening distance between two adjacent substrates from long to short distance in the inlet of the vacuum film deposition apparatus;

FIGS. 3A-3F are illustration views showing a process demonstrating the change of opening distance between two adjacent substrates from short to long distance in the outlet of the vacuum film deposition apparatus;

FIG. 4A is the longitudinal section view of the valve in off-state;

FIG. 4B is the longitudinal section view of the valve in open mode;

FIG. 5 is a sectional view of the inlet of the vacuum film deposition apparatus;

FIG. 6 is a longitudinal section view of the vacuum film deposition chamber; and

FIG. 7 is another longitudinal section view of the vacuum film deposition chamber.

### DETAILED DESCRIPTION OF THE EMBODIMENTS

Detailed description will be given below in conjunction with accompanying drawings.

This invention includes: vacuum deposition chamber which contains film deposition device and is used for depositing film on substrates; at least one inlet vacuum pre-evacuating chamber which contains vacuum pump and connects with the inlet of vacuum deposition chamber; at least one outlet vacuum protection chamber which contains vacuum pump and connects with the outlet of the vacuum deposition chamber; Conveyer which contains transmission belt and wheels, and is used to convey substrates from outside atmosphere air into vacuum deposition chamber for film deposition through inlet vacuum pre-evacuating chamber and from the vacuum deposition chamber into outside atmosphere air through outlet vacuum protection chamber at a certain speed and feeding interval. At least one level of inlet vacuum pre-evacuating chamber is installed in the inlet of vacuum deposition chamber and at least one level of outlet vacuum protection chamber is installed in the outlet of vacuum deposition chamber, making the vacuum degree in the inlet vacuum pre-evacuating chamber and the outlet vacuum protection chamber the same as that in the vacuum deposition chamber and maintaining the vacuum degree in the vacuum deposition chamber unchanged. Each inlet vacuum pre-evacuating chamber, vacuum deposition chamber and outlet vacuum protection chamber are connected with slits and sealed by valves which located in the slits. Substrates are conveyed into each chamber through slits.

One control device, connected with valve, is used to control the valve. The valve is opened as substrate is passing and closed after substrate has passed. Valves locating at the inlet of vacuum deposition chamber are inlet valves, while valves locating at the outlet of vacuum deposition chamber are outlet valves. At least one inlet valve and one outlet valve are closed when the substrate is entering into inlet vacuum pre-evacuating chamber and is leaving the outlet vacuum protection chamber to maintain the vacuum degree in the vacuum deposition chamber unchanged. Each level of inlet vacuum pre-evacuating chamber, each level of outlet vacuum protection chamber and vacuum deposition chamber has its own conveyer, respectively. The substrate conveying speed in each chamber is controlled by its own stepping motor. As a result, the opening distance between adjacent substrates is shortened before reaching the film deposition device in vacuum deposition chamber and enlarged when the film-deposited substrates are conveyed out of vacuum deposition chamber by adjusting the conveying speed of substrate. The substrate conveying speed keeps constant in vacuum deposition chamber. A catch-up zone is installed in the inlet of vacuum deposition chamber to speed up the movement of substrate in the inlet vacuum pre-evacuating chamber and then catch up with its preceding substrate in the vacuum deposition chamber. A separate zone is installed in the outlet of vacuum deposition chamber to speed up the movement of substrate in the outlet vacuum protection chamber and then separate from its following substrate in the separate zone.

If both inlet vacuum pre-evacuating chamber and outlet vacuum protection chamber have two levels, the first level of the pre-vacuum chamber is connected with outside atmosphere air, while the second level with vacuum deposition chamber. The first level of the outlet vacuum protection chamber is connected with outside atmosphere air, while the second level with vacuum deposition chamber. In this case, vacuum film deposition apparatus has three inlet valves and three outlet valves in total. The vacuum pumps in the second level of inlet vacuum pre-evacuating chamber, vacuum deposition chamber and the second level of the outlet vacuum protection chamber operate continuously to keep the vacuum degree in the vacuum deposition chamber unchanged. The vacuum pumps in the first level of the inlet vacuum pre-evacuating chamber and the first level of the outlet vacuum protection chamber are turned on as the inlet valve and outlet valve connecting with outside atmosphere air are closed, and turned off as these valves are opened.

Three inlet valves and three outlet valves of the vacuum film deposition apparatus are all closed initially, and the vacuum pumps in the second level of the inlet vacuum pre-evacuating chamber, vacuum deposition chamber and the second level of the outlet vacuum protection chamber are turned on to ensure that the vacuum degree in the vacuum deposition chamber meets the requirement. After that, the valve connecting with outside atmosphere air is quickly opened as the substrate is conveyed to the inlet slit of the first level of the inlet vacuum pre-evacuating chamber, and then the substrate is rapidly conveyed into the first level of the inlet vacuum pre-evacuating chamber. As long as the substrate has passed the inlet slit of the first level of inlet vacuum pre-evacuating chamber, the inlet valve is rapidly closed and the vacuum pump in the first level of inlet vacuum pre-evacuating chamber is turned on. Meanwhile, the substrate is moving forward at a certain speed. When it reaches the valve between the first and second level of the inlet vacuum pre-evacuating chamber, this valve is opened instantly. Because the pressure in first level and second level of the inlet vacuum pre-evacuating chamber are the same before the substrate arrives at this valve, so the vacuum degree in the second level of inlet vacuum pre-evacuating chamber and the vacuum deposition chamber is unchanged. This valve is quickly closed as the substrate has passed. Meanwhile, the substrate in the second level of inlet vacuum pre-evacuating chamber is moving toward the inlet valve of vacuum deposition chamber. When the substrate arrives at this inlet valve, this valve is opened instantly, and the substrate is conveyed into the vacuum deposition chamber. When the substrate has passed this valve, this valve is closed rapidly. Because the vacuum degree in the second level of the inlet vacuum pre-evacuating chamber and the vacuum deposition chamber is the same, the vacuum degree in the vacuum deposition chamber does not change as the inlet valve of the vacuum deposition chamber is opened for conveying substrate.

After thin film deposition, the film-deposited substrate is conveyed into the second level of outlet vacuum protection chamber through the outlet valve of the vacuum deposition chamber, and then into the first level of outlet vacuum protection chamber through the valve between the first and the second level of the outlet vacuum protection chamber. Once the substrate has passed this valve, this valve is rapidly closed. And then the venting valve of the first level of outlet vacuum protection chamber is opened, once the pressure in the first level of outlet vacuum protection chamber closes to the outside atmosphere, the outlet valve of the first level of outlet vacuum protection chamber is opened, and the film-deposited substrate is conveyed into the conveyer in outside atmosphere. Once the film-deposited substrate leaves the first level of outlet vacuum protection chamber, the venting and outlet valves in first level of outlet vacuum protection chamber are closed and then the vacuum pump in the first level of outlet vacuum protection chamber is turned on.

Before the substrate enters the second level of inlet vacuum pre-evacuating chamber, the opening distance between two adjacent substrates is greater than or equal to the substrate length. Once the inlet valve is opened for passing substrate, the valve between the first and second level of the inlet vacuum pre-evacuating chamber is closed. After the substrate has passed the inlet valve connecting with outside atmosphere air, the inlet valve is quickly closed, and the vacuum pump of the first level of the inlet vacuum pre-evacuating chamber is then turned on. In the same time, the conveying speed of the substrate is reduced to ensure that the vacuum degree in the first level of the inlet vacuum pre-evacuating chamber before opening the valve between the first and the second level of inlet vacuum pre-evacuating chamber is the same as that in the second level of the inlet vacuum pre-evacuating chamber. As its preceding substrate leaves the conveyer in the second level of the inlet vacuum pre-evacuating chamber, the conveying speed of the conveyer in the first and second level of the inlet vacuum pre-evacuating chamber is increased to speed up the movement of the substrate in the first level of the inlet vacuum pre-evacuating chamber and its following substrates. After this substrate in the first level of the inlet vacuum pre-evacuating chamber leaves the valve between the first and second level of inlet vacuum pre-evacuating chamber, the valve between the first and second levels of the inlet vacuum pre-evacuating chamber is closed, and the venting valve in the first level of the inlet vacuum pre-evacuating chamber is opened. When the pressure in the first level of the inlet vacuum pre-evacuating chamber reaches one atmosphere, the inlet valve in the first level of the inlet vacuum pre-evacuating chamber is opened to convey its following substrate into the first level of the inlet vacuum pre-evacuating chamber rapidly. When its preceding substrate is completely conveyed onto the conveyer in the vacuum deposition chamber, the opening distance between these two substrates has been shortened to less than 1 cm from the substrate length. Meanwhile, its following substrate is entirely conveyed into the first level of the inlet vacuum pre-evacuating chamber.

Before the film-deposited substrate is conveyed into the second level of the outlet vacuum protection chamber, the opening distance between two adjacent substrates is less than 1 cm. When this substrate leaves the conveyer of the vacuum deposition chamber, its conveying speed is controlled by the conveyer in the first and the second level of outlet vacuum protection chamber. The opening distance between two adjacent film-deposited substrates is increased from less than 1 cm to greater than or equal to the length of one substrate by varying conveying speed of conveyers in the first and second level of the outlet vacuum protection chamber.

When both inlet pre-vacuum and outlet vacuum protection chambers have only one level, respectively, at least one inlet valve and one outlet valve are closed. Inlet vacuum pre-evacuating chamber, outlet vacuum protection chamber and vacuum deposition chamber have their own independent conveyer for conveying substrate, respectively. The substrate conveying speed is controlled by step motor. The vacuum pump in the vacuum deposition chamber operates continuously to ensure that the vacuum deposition chamber is under vacuum state. The vacuum pumps in the inlet and exit chamber are turned on when the inlet and outlet valves connecting with outside atmosphere air are closed, and turned off when these valves are opened.

Initially, both valves adjacent to vacuum deposition chamber are closed to ensure that the vacuum deposition chamber is under vacuum state. The substrate is quickly conveyed into the inlet vacuum pre-evacuating chamber through the inlet valve at the atmosphere air end of the inlet vacuum pre-evacuating chamber. Once the substrate is in the inlet vacuum pre-evacuating chamber, the inlet valve connecting with outside atmosphere air is quickly closed and the vacuum pump in the inlet vacuum pre-evacuating chamber is turned on. When the vacuum degree in the inlet vacuum pre-evacuating chamber is the same as that in the vacuum deposition chamber, the valve between the inlet vacuum pre-evacuating chamber and the vacuum deposition chamber is opened, and the substrate is conveyed to the vacuum deposition chamber at a fast conveying speed. At that moment, its preceding substrate leaves the conveyer of the inlet vacuum pre-evacuating chamber entirely and moves forward slowly on the conveyer in the vacuum deposition chamber. When the whole preceding substrate is on the conveyer in the vacuum deposition chamber, the opening distance between these two substrates has been shortened to less than 1 cm from greater than or equal to the length of substrate. After that, the conveying speed of the conveyer in the inlet vacuum pre-evacuating chamber is reduced to be the same as that of the conveyer in the vacuum deposition chamber. Once the substrate leaves the conveyer in the inlet vacuum pre-evacuating chamber, the valve between the inlet vacuum pre-evacuating chamber and the vacuum deposition chamber is closed. The venting valve in the inlet vacuum pre-evacuating chamber is opened to increase the pressure in the inlet vacuum pre-evacuating chamber. Once it reaches one atmosphere, the inlet valve connecting with atmosphere air is opened for its following substrate to be conveyed into the inlet vacuum pre-evacuating chamber. Once the following substrate is in the inlet vacuum pre-evacuating chamber in whole, the inlet valve connecting with atmosphere air is closed and the vacuum pump in the inlet vacuum pre-evacuating chamber is turned on. When the vacuum degree in the inlet vacuum pre-evacuating chamber is the same as that in the vacuum deposition chamber, the valve between the inlet vacuum pre-evacuating chamber and the vacuum deposition chamber is opened for the following substrate to catch up with the substrate which is not fully in the conveyer of the vacuum deposition chamber but moves forward at a slow speed.

Before film-deposited substrate enters outlet vacuum protection chamber, the opening distance between two adjacent substrates is less than 1 cm. After this substrate leaves the conveyer in the vacuum deposition chamber, its conveying speed is controlled by the conveyer in the outlet vacuum protection chamber. The opening distance between two adjacent film-deposited substrates is enlarged from 1 cm to greater than or equal to the length of the substrate by varying conveying speed of the conveyer in the outlet vacuum protection chamber.

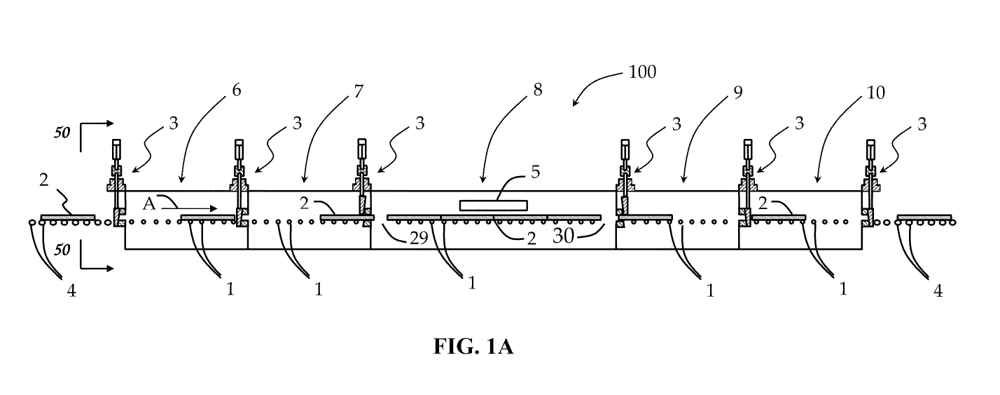

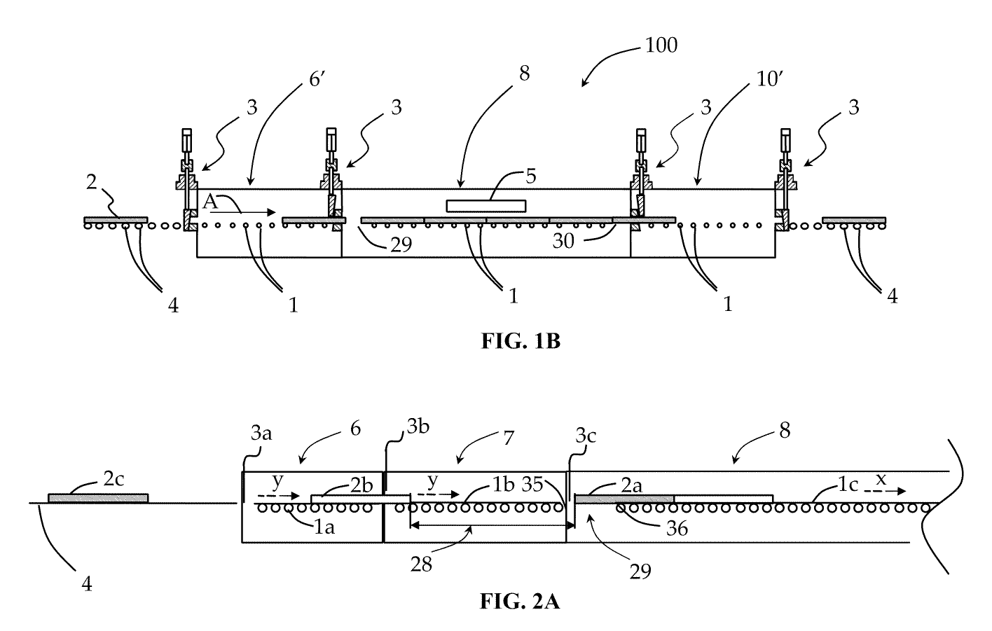

As illustrated in FIG. 1A, the vacuum film deposition apparatus 100 consists of a first level of inlet vacuum pre-evacuating chamber 6, a second level of inlet vacuum pre-evacuating chamber 7 and a vacuum deposition chamber 8, a second level of outlet vacuum protection chamber 9 and a first level of outlet vacuum protection chamber 10. The sealing between chambers is achieved with valve 3. Similarly, the valve 3 is also used as the sealing element between the first level of the inlet vacuum pre-evacuating chamber 6 and outside atmosphere air, between the first level of the outlet vacuum protection chamber 10 and outside atmosphere air. The first level of the inlet vacuum pre-evacuating chamber 6 is used as the inlet of the inlet vacuum pre-evacuating chamber. After a substrate 2 enters the first level of the inlet vacuum pre-evacuating chamber 6, firstly, the valve between the first level of the inlet vacuum pre-evacuating chamber 6 and outside atmosphere air is closed, then the vacuum pump in the first level of the inlet vacuum pre-evacuating chamber 6 is turned on to vacuum down the first level of the inlet vacuum pre-evacuating chamber 6. The vacuum degree of the first level of the inlet vacuum pre-evacuating chamber 6 is required to be close to that of the second level of the inlet vacuum pre-evacuating chamber 7. As a result, no pressure difference is present between the first level 6 and the second level 7 of the inlet vacuum pre-evacuating chamber when valve 3 between these two levels of inlet vacuum pre-evacuating chamber is opened. At the inlet of the vacuum film deposition apparatus 100, only the first level of the inlet vacuum pre-evacuating chamber 6 contacts with outside atmosphere air directly, while the second level of the inlet vacuum pre-evacuating chamber 7 and the vacuum deposition chamber 8 do not contact with outside atmosphere air directly. The second level of the inlet vacuum pre-evacuating chamber 7 is used as a buffering level to keep its vacuum degree unchanged, so that the vacuum deposition chamber 8 doesn't contact with outside atmosphere air directly and the deposition environment in the vacuum deposition chamber 8 keeps steady. In the meantime, the second level of the inlet vacuum pre-evacuating chamber 7 is also used to pre-heat substrate as required. Based on the requirement of vacuum film deposition, thermal insulating material and heating elements are installed in the second level of the inlet vacuum pre-evacuating chamber 7 to pre-heat substrate 2. Because of no contacting with the outside atmosphere air and steady vacuum degree, the loss of heat is relatively small. It is quite energy-saving to use this chamber as a pre-heat chamber. The substrate 2 is conveyed into the first level of the inlet vacuum pre-evacuating chamber 6 by conveyer 4 from outside atmosphere air. After the first level of the inlet vacuum pre-evacuating chamber 6 becomes vacuum from one atmosphere, the valve 3 between the first level 6 and the second level 7 of the inlet vacuum pre-evacuating chamber is opened. The substrate 2 is thus conveyed to the second level of the inlet vacuum pre-evacuating chamber 7 by transmission wheel 1. By varying speed of the transmission wheel 1, substrate catches up with its preceding one in the catch-up zone 29. The opening distance between two adjacent substrates has been shortened to less than 1 cm when the whole preceding substrate is in the vacuum deposition chamber 8. This process will be described in details further later.

The vacuum degree remains at a constant level in the vacuum deposition chamber 8 which contains film deposition device 5. The number of the film deposition device 5 installed in the deposition chamber 8 can be increased or decreased based on film deposition requirement. Thin film is deposited on substrate 2 when it passes through film deposition device 5. The substrate 2 is supported and conveyed by transmission wheel 1 which is made of stainless steel and could withstand at least 500° C. If the vacuum deposition process needs a higher temperature, other heat resistant materials such as silicon carbide, silicon nitride and graphite etc, can be used instead of stainless steel.

The second level of outlet vacuum protection chamber 9 has a similar function to the second level of the inlet vacuum pre-evacuating chamber 7. It is used to keep the vacuum deposition chamber in vacuum state. Meanwhile, the second level of the outlet vacuum protection chamber 9 can also be used as a post-processing chamber. Its temperature can be kept at a required value to post-treat film-deposited substrate 2. The function of the first level of the outlet vacuum protection chamber 10 is contrary to that of the first level of the inlet vacuum pre-evacuating chamber 6: its status changes from vacuum to atmosphere when substrate 2 enters. As a result, the second level of outlet vacuum protection chamber 9 does not contact with atmosphere air, ensuring that the deposition environment inside the vacuum deposition chamber 8 is steady. The substrates are conveyed into the second level of outlet vacuum protection chamber 9 by transmission wheel 1. In the separate zone 30, the opening distance between two adjacent substrates is enlarged from less than 1 cm by varying the speed of the transmission wheel 1. The opening distance between two adjacent substrates is increased to be the same as that before they enter the second level of inlet vacuum pre-evacuating chamber 7 when substrate 2 is conveyed into the first level of outlet vacuum protection chamber 10. In the meanwhile, the pressure in the first level of outlet vacuum protection chamber 10 is increased up to one atmosphere from vacuum when substrate 2 is inside. When the pressure in the first level of outlet vacuum protection chamber 10 reaches one atmosphere, film-deposited substrate is conveyed out of vacuum deposition system 100 by transmission wheel 1 to conveyer 4 in the outside atmosphere air. This process will be described in details further later.

Refers to FIG. 1B, there is only one level of inlet vacuum pre-evacuating chamber and outlet vacuum protection chamber, respectively. When substrate 2 enters inlet vacuum pre-evacuating chamber 6′, the valve 3 between inlet vacuum pre-evacuating chamber 6′ and outside atmosphere air is closed first, vacuum pump 6 in the inlet vacuum pre-evacuating chamber 6′ is then turned on to make the inlet vacuum pre-evacuating chamber 6′ under vacuum state from atmosphere. When the vacuum degree in the inlet vacuum pre-evacuating chamber is the same as that in the vacuum deposition chamber 8, valve 3 between the inlet vacuum pre-evacuating chamber 6′ and vacuum deposition chamber 8 is opened for conveying substrate 2 into the vacuum deposition chamber 8 by transmission wheel 1. Meanwhile, the substrate catches up with its preceding substrate in catch-up zone 29 by varying speed of transmission wheel 1. The opening distance between two adjacent substrates becomes less than 1 cm before film deposition. After thin film deposition, the film-deposited substrate is conveyed into outlet vacuum protection chamber 10′, and the opening distance between two adjacent substrates is increased in separate zone 30 by varying the speed of transmission wheel 1. After substrate 2 enters outlet vacuum protection chamber 10′, the valve 3 between vacuum deposition chamber 8 and the outlet vacuum protection chamber 10′ is closed, and the venting valve in the outlet vacuum protection chamber 10′ is opened to increase the pressure of the outlet vacuum protection chamber 10′ from vacuum to one atmosphere. After that, the film-deposited substrate 2 is conveyed out of vacuum film deposition apparatus 100 to conveyer 4 in the outside atmosphere air.

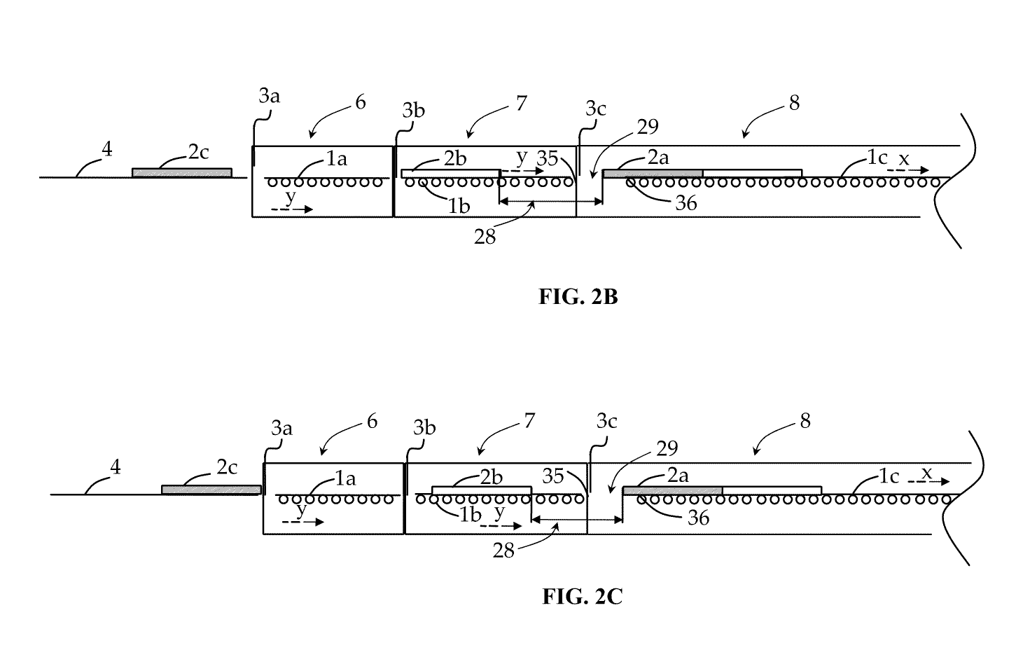

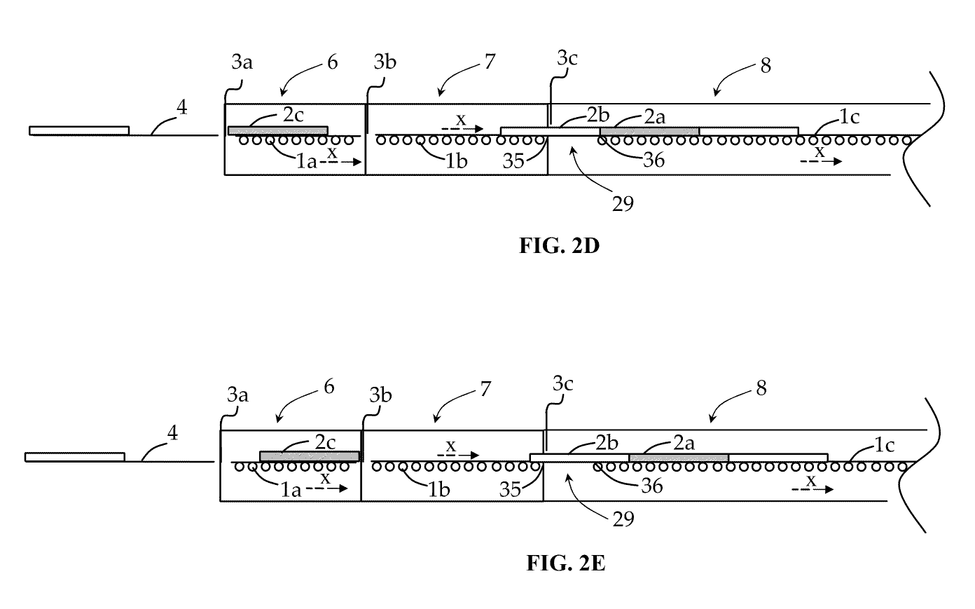

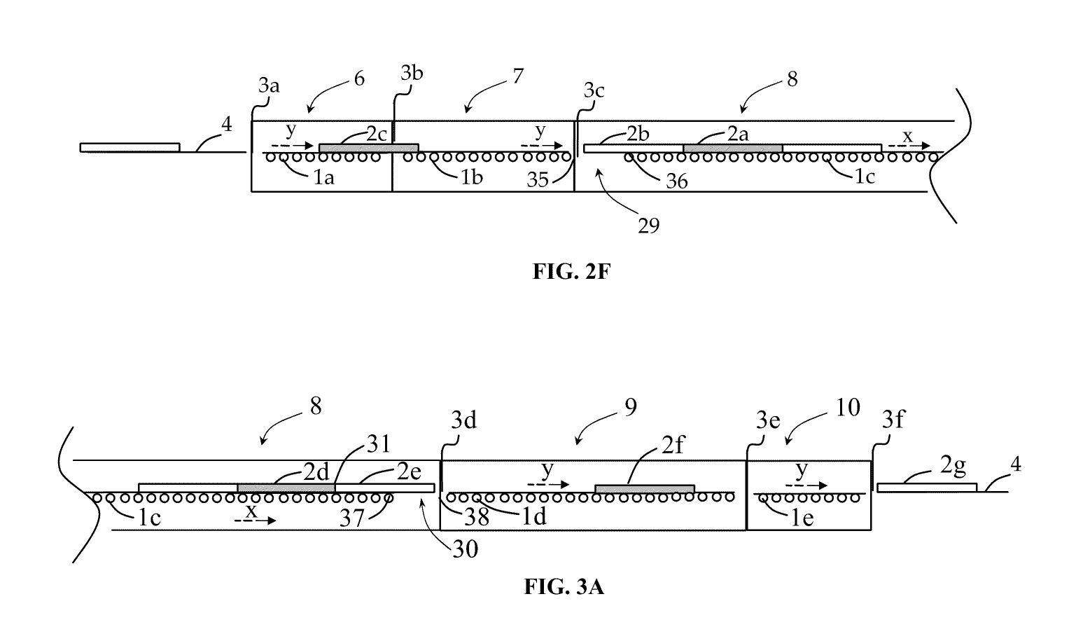

FIGS. 2A-2F illustrate the process of reducing the opening distance between two adjacent substrates continuously from a certain distance to continuous arrangement (less than 1 cm of opening distance) by varying the speed of transmission wheel 1 at the inlet. In the meanwhile, the vacuum degree in the vacuum deposition chamber remains constant when substrate is conveyed from outside atmosphere air to the vacuum deposition apparatus 100. The continuous arrangement of substrates in the vacuum deposition chamber 8 is beneficial to enhancing the utilization rate of materials for deposition. The transmission wheels in inlet vacuum pre-evacuating chamber 6, 7 and vacuum deposition chamber 8 are defined as 1a, 1b, and 1c, respectively; three inlet valves from the first level of inlet vacuum pre-evacuating chamber 6 to vacuum deposition chamber 8 are defined as 3a, 3b and 3c, respectively. As shown in the figures, there is a catch-up zone 29 which does not have transmission wheel 1 at the left end of the vacuum deposition chamber 8. 28 is the distance between two adjacent substrates. The conveying speed of the transmission wheel 1c is a constant value x, while the conveying speed of transmission wheels 1a and 1b is the same and adjustable: fast speed y and slow speed x. The conveying speed of substrate on conveyer 4 outside the first level of inlet vacuum pre-evacuating chamber 6 is the same as that in the inlet vacuum pre-evacuating chamber. The process of reducing the opening distance between adjacent substrates at the inlet is illustrated in details by explaining the conveying pattern of three adjacent substrates 2a, 2b, and 2c. The following is the detail illustration of substrate location, valve state and vacuum degree of chambers at 6 different moments. The second level of inlet vacuum pre-evacuating chamber 7 and the vacuum deposition chamber 8 remains vacuum state all the time while the vacuum degree in the first level of inlet vacuum pre-evacuating chamber 6 can be changed.

At the moment illustrated in FIG. 2A, substrate 2a detaches from transmission wheel 1b and is entirely on transmission wheel 1c, and its end is at the starting point 35 of catch-up zone 29. Substrate 2a moves forward at a slow speed x in the vacuum deposition chamber 8, while substrate 2b is on the transmission wheel 1a and 1b. At that time, the conveying speed of transmission wheel 1a and 1b changes from slow speed x to fast speed y while the conveying speed of transmission wheel 1c is slow speed x. Since the conveying speed of substrate 2b is faster than that of substrate 2a, the opening distance between substrate 2a and 2b becomes smaller gradually. At this moment, the valve 3a is in off-state, the valve 3b is in open mode and the valve 3c is just closed. The first level of inlet vacuum pre-evacuating chamber 6 is in vacuum state.

At the moment illustrated in FIG. 2B, the transmission wheel 1c conveys substrate 2a forward at a speed x, while the transmission wheel 1b and conveyer 4 conveys substrate 2b and 2c forward at a speed y, thus the opening distance between substrate 2a and 2b shortens further and the end of substrate 2a is already in the middle of the catch-up zone 29. At this moment, substrate 2b already enters the second level of inlet vacuum pre-evacuating chamber 7, the valve 3b is just closed, and substrate 2a has not entered the first level of inlet vacuum pre-evacuating chamber 6 and is still away from valve 3a. At that time, the first level of inlet vacuum pre-evacuating chamber 6 begins venting until reaching atmosphere. The valves of 3a, 3b, and 3c are in off-state at this moment.

At the moment illustrated by FIG. 2C, substrate 2c is about to enter the first level of inlet vacuum pre-evacuating chamber 6, valve 3c is about to be opened and the pressure in first level of inlet vacuum pre-evacuating chamber 6 has been raised to atmosphere. At this moment, the conveying speed of the conveyer 4 outside the first level of inlet vacuum pre-evacuating chamber 6 is y. The fast running transmission wheel 1a and conveyer 4 are coordinated to convey substrate 2c quickly into the first level of inlet vacuum pre-evacuating chamber 6, ensuring that the time of valve 3a in open mode is the shortest. The substrate 2b is still catching up with the substrate 2a at a fast speed y. The opening distance 28 between these two substrates becomes even smaller further. At this moment, these three valves are in off-state.

Next moment is illustrated in FIG. 2D. At this moment, the end of substrate 2a already reaches the end-point 36 of catch-up zone 29, i.e., on transmission wheel 1c. Once the head of substrate 2b contacts transmission wheel 1c, the speed of the transmission wheel 1a and 1b become slow speed x, the same as that of 1c because the substrate 2b is on both transmission wheel 1b and 1c. Substrate 2b has caught up with the preceding substrate 2a after a period of fast conveying. Thus the opening distance 28 between substrate 2b and substrate 2a can be shortened to 0 cm. Based on real requirements in vacuum thin film deposition, the final opening distance between substrates can be achieved by varying the conveying speed x and y. At this moment, the whole substrate 2c just enters the first level of inlet vacuum pre-evacuating chamber 6, and valve 3a is just closed. The first level of inlet vacuum pre-evacuating chamber 6 begins to be vacuumed. Because the transmission wheel 1a changes from fast speed y to slow speed x, the time for exhausting the first level of inlet vacuum pre-evacuating chamber 6 is greatly increased, ensuring that vacuum degree in the first level of inlet vacuum pre-evacuating chamber 6 is the same as that in the second level of inlet vacuum pre-evacuating chamber 7 before substrate 2c reaches valve 3b. As a result, valve 3b can be opened smoothly. At this moment, valve 3a and 3b are in off-state while valve 3c is in open mode.

At the moment illustrated in FIG. 2E, substrate 2c is conveyed into the front of valve 3b and is about to enter the second level of inlet vacuum pre-evacuating chamber 7. At this moment, the vacuum degree in the first level of inlet vacuum pre-evacuating chamber 6 meets the requirements and is the same as that in the second level of inlet vacuum pre-evacuating chamber 7. No pressure difference is present between two ends of valve 3b, so it can be opened smoothly. Because substrate 2b is still on transmission wheel 1b, the transmission wheel 1a, 1b and 1c keep moving at slow speed x. At this moment, valve 3a and 3b are in off-state, and 3c is in open mode.

At the moment illustrated in FIG. 2F, the substrate 2b has already detached from transmission wheel 1b and moves at slow speed x, and the end of substrate 2b is at the starting point 35 of catch-up zone 29. Substrate 2c is on both transmission wheel 1a and 1b. At this moment, the conveying speed of transmission wheel 1a and 1b changes from slow speed x to fast speed y, while the conveying speed of transmission wheel 1c keeps at constant x. Since the conveying speed of substrate 2c is faster than that of substrate 2b, the opening distance between substrate 2b and 2c becomes smaller gradually. At this moment, the valve 3a is in off-state, valve 3b in open mode, and valve 3c is just closed. The first level of inlet vacuum pre-evacuating chamber 6 is in vacuum state. The status at this moment is the same as that illustrated in FIG. 2A.

The FIGS. 2A-2F illustrate one operation cycle of the continuous vacuum deposition production system at the inlet of vacuum film deposition apparatus. Substrate 2 accomplishes a process of shortening the opening distance 28 between adjacent substrates from a large distance to less than 1 cm at the inlet. In the meanwhile, In addition, the degree of vacuum in the vacuum deposition chamber 8 does not change with the transportation of substrate 2 from outside atmosphere air to vacuum film deposition system. During the film deposition process, the degree of vacuum in deposition chamber 8 keeps constant. Because the opening distance between two adjacent substrates in the vacuum deposition chamber 8 is controlled to be less than 1 cm, the loss of materials used for film deposition in the opening space between adjacent substrates is negligible during the process of film deposition. Therefore, the film deposition can be operated continuously.

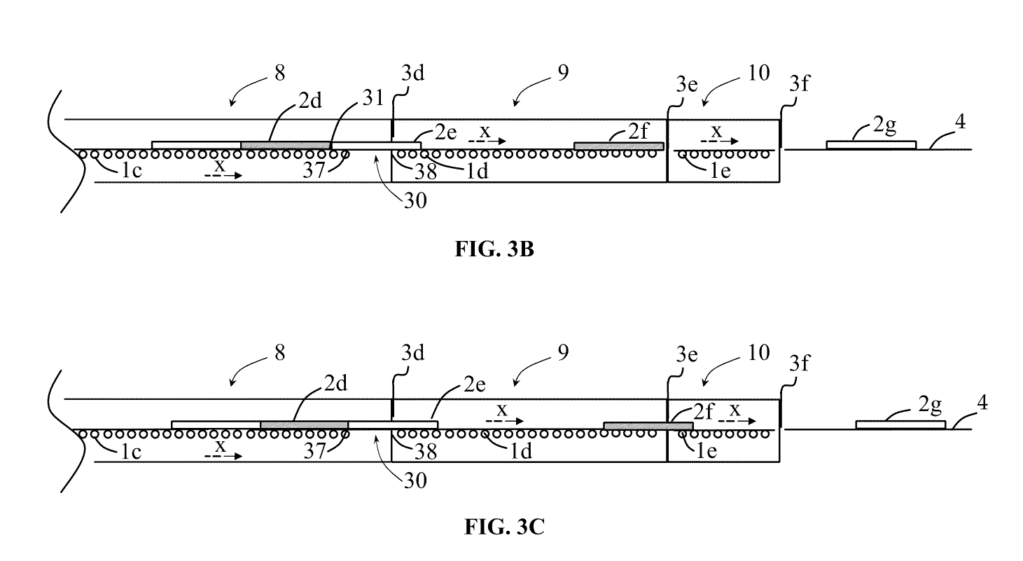

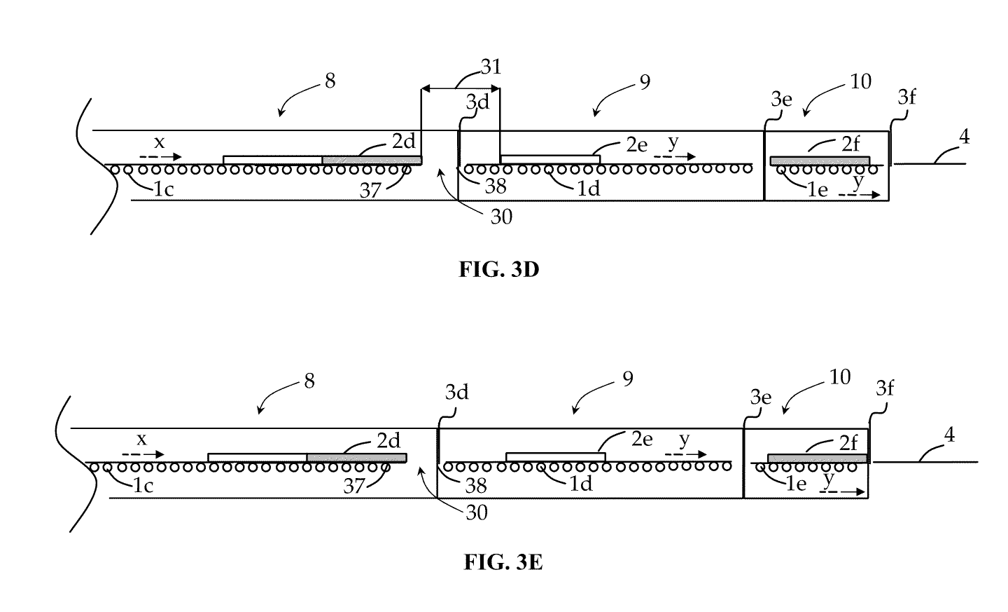

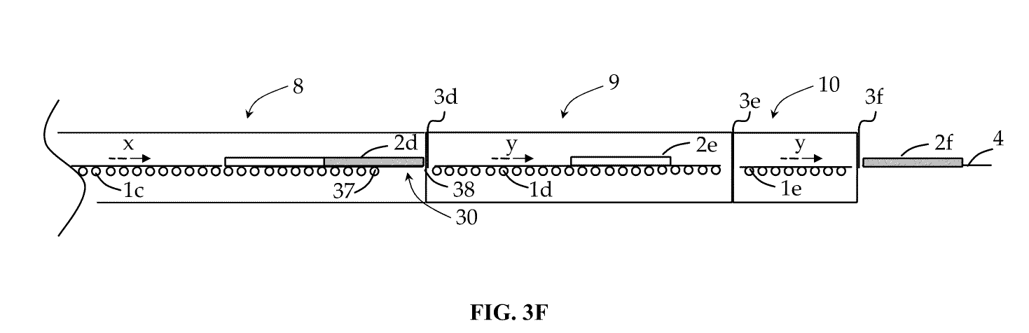

After accomplishing the vacuum film deposition, a similar method is used to increase the opening distance between adjacent substrates 2 from less than 1 cm to the original distance 28. In addition, the degree of vacuum in vacuum deposition chamber 8 does not change with the transportation of substrate 2 from vacuum film deposition system to outside atmosphere air. This process will be illustrated in FIGS. 3A-3F.

FIGS. 3A-3F illustrate the process of increasing the opening distance between adjacent substrates which are in continuous arrangement (less than 1 cm of opening distance) in separate zone 30 by varying the conveying speed of transmission wheel 1c, 1d, and 1e in vacuum deposition chamber 8, the second level of outlet vacuum protection chamber 9 and the first level of outlet vacuum protection chamber 10 in the vacuum deposition system 100. FIG. 3 shows four substrates 2d, 2e, 2f and 2g. The process of enlarging opening distance is demonstrated by changing the opening distance between 2d and 2e. The transmission wheel is divided into three sections: 1c in the vacuum deposition chamber 8, 1d in the second level of outlet vacuum protection chamber 9 and 1e in the first level of outlet vacuum protection chamber 10. 1c conveys at slow speed x, while 1d and 1e conveys at the same speed which can be varied, fast speed y and slow speed x. FIG. 3 contains three valves: the valve 3d between the vacuum deposition chamber 8 and the second level of outlet vacuum protection chamber 9; the valve 3e between the second level of exit protection chamber 9 and the first level of outlet vacuum protection chamber 10; the valve 3f between the first level of outlet vacuum protection chamber 10 and the outside atmosphere air. The vacuum deposition chamber 8 and the second level of outlet vacuum protection chamber 9 are in vacuum state all the time while the degree of vacuum in first level of outlet vacuum protection chamber 10 changes with the conveying of film-deposited substrate 2.

At the moment illustrated in FIG. 3A, the opening distance between two adjacent substrates 2d and 2e is less than 1 cm, the front of substrate 2e is about to leave the separate zone 30 and move on transmission wheel 1d through valve 3d. The conveying speed of transmission wheel 1c is x and the conveying speed of transmission wheel 1d and 1e is fast speed y. Once the substrate 2e reaches the transmission wheel 1d, the conveying speed of the transmission wheel 1d and 1e immediately changes to slow speed x. At this moment, the opening distance between the substrate 2e and its preceding substrate 2f becomes the largest, which is the same as that before the substrates enter valve 3a at the inlet. The substrate 2g has been conveyed out of the vacuum deposition apparatus 100, and the valve 3f is just closed. The first level of vacuum protection chamber 10 starts to be vacuumed to ensure that the pressure at the both sides of valve 3f is the same when the valve 3e is opened. Because substrate 2f is away from valve 3e, and transmission wheel 1d conveys at slow speed x, the time for substrate 2f to be conveyed to the valve 3e is significantly increases, maximizing the vacuuming time of the first level of exit chamber 10. At this moment, all three valves are in off-state.

At the moment illustrated in FIG. 3B, the front of substrate 2e is already on the transmission wheel 1d, but the substrate 2e doesn't detach from the transmission wheel 1c. The transmission wheel 1c, 1d and 1e convey at slow speed x, and the opening distance between substrate 2e and 2f is still less than 1 cm; the substrate 2f has been conveyed to the front of valve 3e and is ready to enter the first level of outlet vacuum protection chamber 10. At this moment, the pressure in the first level of outlet vacuum protection chamber 10 is the same as that in the second level of outlet vacuum protection chamber 9, the valve 3e can be opened smoothly. At this moment, valve 3d is in open mode while valve 3e and 3f are in off-state. The first level of outlet vacuum protection chamber 10 is in vacuum state.

At the moment illustrated in FIG. 3C, substrate 2e just leaves the transmission 1c entirely, the later part of substrate 2e is still in the separate zone 30, and the front of substrate 2d just enters the starting point 37 of the separate area 30. The transmission wheel 1d and 1e run at fast speed y while transmission wheel 1c at slow speed x. Thus when the substrate 2d passes through the separate zone 30 at slow speed x, substrate 2e is conveyed into the second level of outlet vacuum protection chamber 9 at fast speed y, resulting in the increase of opening distance between substrate 2d and 2e. The substrate 2f is being conveyed to the first level of outlet vacuum protection chamber 10. At this moment, the valve 3d and 3e are in open mode while the valve 3f is in off-state. Because the first level of outlet vacuum protection chamber 10 is in vacuum state at this moment, the degree of vacuum in the vacuum deposition chamber 8 and the second level of outlet vacuum protection chamber 9 is maintained.

At the moment illustrated in FIG. 3D, substrate 2e has already entered the second level of outlet vacuum protection chamber 9, the valve 3d has been closed, the transmission wheel 1d and 1e run at a fast speed y, the front of substrate 2d running at slow speed x is still in the separate zone 30. The opening distance between the substrate 2d and 2e has been increased to the distance shown in FIG. 3D. As the whole substrate 2f enters the first level of outlet vacuum protection chamber 10, valve 3e is closed and the venting valve in the first level of outlet vacuum protection chamber 10 is opened to make the pressure on both sides of valve 3f the same, which is required to open valve 3f smoothly. At this moment, valve 3d, 3e and 3f are all in off-state.

The difference between FIGS. 3E and 3D is that the substrate 2f has already been conveyed to the front of valve 3f, the pressure of the first level of outlet vacuum protection chamber 10 achieves atmosphere and valve 3f is about to be opened. Therefore, there is no pressure difference between two sides of valve 3f when valve 3f is opened. At this moment, valve 3d and 3e are in off-state, valve 3f is about to be opened.

At the moment illustrated in FIG. 3F, the front of substrate 2d is about to touch valve 3d which is in off-state, the transmission wheel 1e runs at speed x, while the transmission wheel 1d and 1e still run at fast speed y. Once substrate 2d touches the transmission wheel 1d through valve 3d, the conveying speed of transmission wheel 1d and 1e is immediately reduced to speed x, and the opening distance between substrate 2d and 2e becomes the largest which is equals to the distance 28 before substrates enter vacuum film deposition apparatus. Substrate 2f has already been conveyed out of the vacuum film deposition apparatus. Valve 3f is closed, the first level of outlet vacuum protection chamber 10 is vacuumed to be vacuum from atmosphere, making the pressure between two sides of valve 3e the same when it is opened. As a result, the substrate 2e can enter the first level of outlet vacuum protection chamber 10 through valve 3e smoothly. When substrate 2d passes through valve 3d, the conveying speed of transmission wheel 1d is slow speed x, the time for the substrate 2e to be conveyed from the location in FIG. 3F to the valve 3e is extended, maximizing the vacuuming time of the first level of outlet vacuum protection chamber 10 into vacuum.

The state of FIG. 3F is the same as that of FIG. 3A. FIGS. 3A-3F is one operation cycle of the continuous vacuum deposition production apparatus in the outlet of vacuum film deposition apparatus 100. In addition, the degree of vacuum in the vacuum deposition chamber 8 does not change with the transportation of film-deposited substrate 2 from vacuum film deposition apparatus 100 to outside atmosphere air.

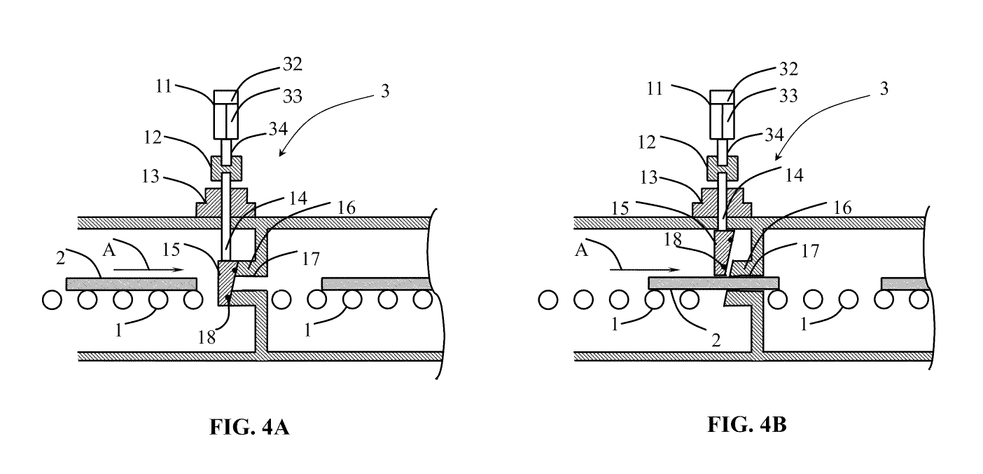

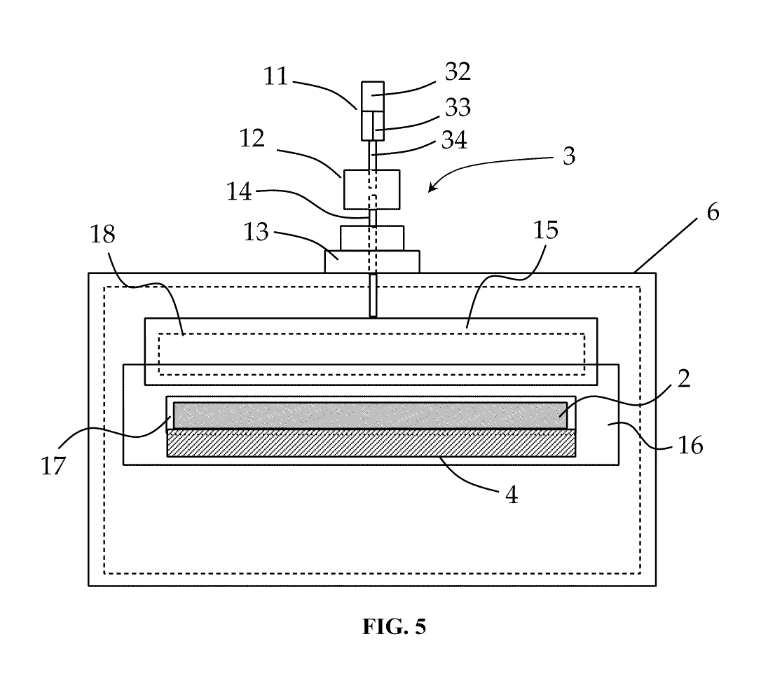

FIGS. 4A and 4B illustrate the schematic diagram of valve 3 in open mode and off-state. Valve 3 consists of cylinder 11, coupling 12, cylinder base 13, cylinder rod 34, valve rod 14, movable valve plate 15, fixed valve plate 16, slit 17 and rubber ring 18. Substrate 2 enters another chamber through slit 17 in the valve 3.

FIG. 4A shows the valve in off-state. The upper space 32 of cylinder 11 is charged with gas, driving the cylinder rod 34 to press down, and the valve rod 14 driven by coupling 12 also presses down, thus the movable valve plate 15 touches the fixed valve plate 16. Since the contact plane of movable valve plate 15 with fixed valve plate 16 is an inclined plane, there is a radial component force on the direction of perpendicular to the inclined plane when these two valve plates touch each other. In addition, there is a rubber ring 18 on movable valve plate 15, the radial component force can hold down the rubber ring to seal slit 17. As the substrate 2 closes, the valve 3 is opened to let the substrate 2 enter another chamber through the slit 17 on valve 3. As illustrated in FIG. 4B, when the valve 3 is opened, the low space 33 in cylinder 11 is charged with gas to uplift the cylinder rod 34, and the valve rod 14 driven by coupling 12 also uplift to open the slit 17. As a result, the substrate 2 can enter another chamber through the slit 17.

FIG. 5 is a sectional view of inlet of the vacuum deposition apparatus shown in FIG. 1A along direction 50. It illustrates the structure of valve 3 from another angle. 4 is a conveyer for conveying substrate outside the first level of inlet vacuum pre-evacuating chamber 6, the height of slit 17 is slightly greater than the thickness of substrate 2. When the substrate 2 enters the slit 17 and lies in the middle of the slit, so that there is a certain space on both surfaces of substrate 2 to make it pass through smoothly. Similarly, the width of slit 17 is also slightly greater than that of the substrate 2, so that there is a small space in the left and right side of substrate 2 when it passes through the valve. The size of these spaces is within 5 mm. Therefore, when the second level of outlet vacuum protection chamber 7 needs to be heated, the loss of heat from the spaces between slit 17 and substrate 2 is minimized.

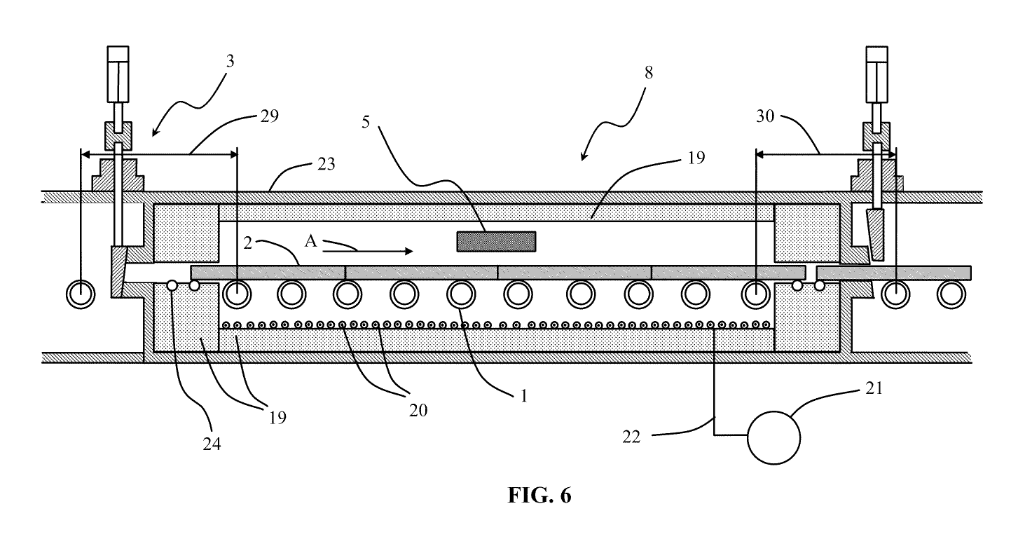

FIG. 6 is a longitudinal section view of vacuum deposition chamber 8. The vacuum deposition chamber 8 includes vacuum pump 21, exhaustion pipeline 22, catch-up zone 29, separate zone 30, heating element 20, thermal insulating material 19, transmission wheel 1, deposition device 5 and vacuum chamber wall 23. A is the conveying direction of substrate 2, substrate 2 is arranged continuously in the deposition chamber 8 with less than 1 cm of opening distance between each other. During film deposition, deposition device 5 provides vapor source of film material. The vapor source is deposited on the upper surface of the continuously arranged substrates 2 which are conveyed along the A direction using film deposition technology, such as chemical vapor deposition, vacuum evaporation, sputtering, organometallic vapor deposition, epitaxial film vacuum deposition, chemical vapor transfer deposition, sublimation deposition, close-spaced sublimation deposition. The chemical vapor transfer deposition is to use inert gas to bring the compound materials into the vacuum device 5 in the vacuum deposition chamber. In the deposition device 5, the compound materials sublimate or evaporate into vapor, then deposits on the substrate 2 which surface temperature is lower than the compound vapor temperature with the help of inert gas. The compound materials include CdTe, CdS, ZnTe and such all semiconductors, metals, non-metallic materials that can sublimate or evaporate in vacuum. The close-spaced sublimation deposition is to heat the solid compound in the deposition device 5 to be vapor that diffuses to reach the surface of substrate 2 which surface temperature is lower than the compound vapor and deposits as film. Similarly, the deposited compound materials including CdTe, CdS, ZnTe and such all semiconductors, metals, non-metallic materials that can sublimate or evaporate in vacuum. When sputtering technology is used to deposit film, the deposition device 5 is the cathode in sputtering deposition system. Sputtering targets are installed in the cathode. All insulators, conductors, semiconductors can be used as targets for sputtering.

Since the length of both catch-up zone 29 and separate zone 30 is not short, balancing wheel 24 needs to be installed in these two zones to support the substrate 2 in order to convey the substrate 2 smoothly. The chamber and substrate are heated and insulated with heating element 20 and thermal insulating material 19 which are installed in deposition chamber. The heating element 20 can be resistance wire, halogen lamp and heating quartz tube and so on.

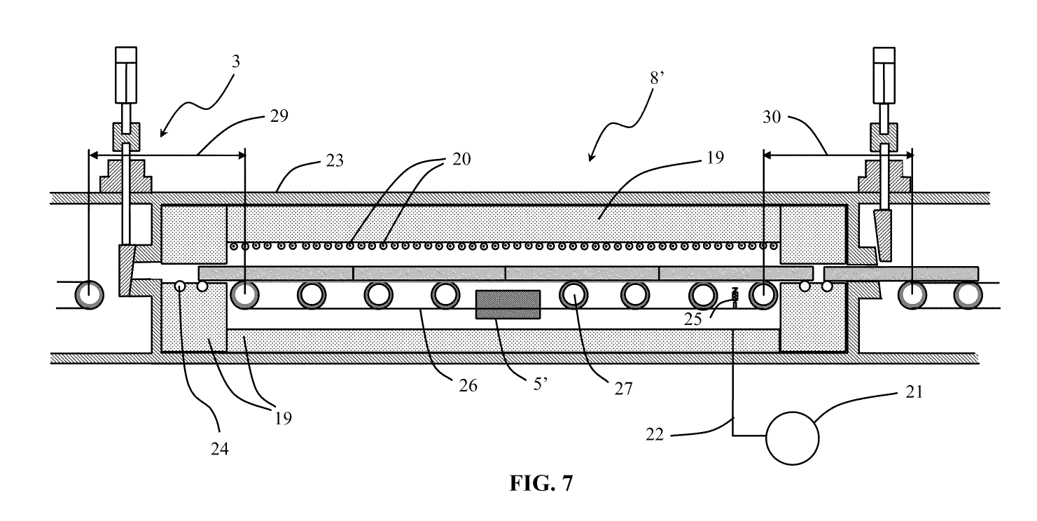

FIG. 7 is another deposition embodiment of vacuum film deposition. In the vacuum deposition chamber 8′ illustrated in FIG. 7, the deposition device 5′ is installed below the substrate 2. The film is deposited on the lower surface of the continuously arranged substrates 2 which are conveyed along the A direction from vapor source using film deposition technology, such as chemical vapor deposition, vacuum evaporation, sputtering, organometallic vapor deposition, epitaxial film vacuum deposition, chemical vapor transfer deposition, sublimation deposition, and close-spaced sublimation deposition, etc. In order to achieve this kind of film deposition, the arrangement of the transmission wheel 1 under the substrate 2, illustrated in FIG. 6, needs to be changed since the film on the surface substrate 2 cannot contact the conveyer. Otherwise, the film on substrate 2 will be damaged. Therefore, the conveying of substrate 2 in the vacuum deposition production line is achieved by metal strip belts 26 installed on both sides of substrate, not transmission wheel 1. The metal strip belts 26 is supported by balancing wheels 27 to keep the metal strip belts 26 from bending. The width of metal strip belts 26 is about 2 cm or less, the diameter of balancing wheels 27 is equal to or greater than the width of metal strip belts 26. The deposition device 5′ locates between two metal strip belts. In order to eliminate the film deposition on metal strip belts 26 and balancing wheels 27, the balancing wheels 27 and metal strip belts 26 may be covered with material which can be cleaned regularly. Since the film deposited on the lower surface of substrate 2 does not contact with the metal strip belts 26 and balancing wheels 27, it will not be damaged in conveying process. Metal strip belts on the both sides of substrate 2 can convey the substrate directly, but its stability is not as good as the combination of balancing wheel and metal strip belts. The predetermined tension of the metal strip belts in the vacuum deposition chamber is controlled and adjusted by a belt tensioner 25.

While particular embodiments of the invention have been shown and described, it will be obvious to those skilled in the art that changes and modifications may be made without departing from the invention in its broader aspects, and therefore, the aim in the appended claims is to cover all such changes and modifications that fall within the true spirit and scope of the invention.

The invention claimed is:

1. A method for continuously depositing thin film in vacuum, comprising the following steps:
A) maintaining the degree of vacuum in the inlet vacuum pre-evacuating chamber and the outlet vacuum protection chamber locating at both ends of vacuum deposition chamber the same as that in the vacuum deposition chamber to ensure that the degree of vacuum in the vacuum deposition chamber keeps unchanged by disposing at least one level of inlet vacuum pre-evacuating chamber at the inlet of the vacuum deposition chamber and at least one level of outlet vacuum protection chamber at the outlet of the vacuum deposition chamber;
B) connecting each level of inlet vacuum pre-evacuating chamber, vacuum deposition chamber and each level of outlet vacuum protection chamber by slits and sealing with valves located in slits, the valves at the inlet of vacuum deposition chamber are inlet valves, while the valves at the outlet of vacuum deposition chamber are outlet valves, substrates enter each chamber through slits, and the valves are opened when the substrate is passing and is closed after the substrate has passed;
C) conveying the substrates from the outside atmosphere air through the inlet vacuum pre-evacuating chamber to the vacuum deposition chamber for film deposition and conveying the substrates through the outlet vacuum protection chamber to the outside atmosphere air by the substrates at a certain speed and interval; and
D) keeping at least one inlet valve and one outlet valve closed when the substrate is entering into the inlet vacuum pre-evacuating chamber and is leaving the outlet vacuum protection chamber, to keep the degree of vacuum in the vacuum deposition chamber unchanged.

2. The method of claim 1, wherein the method further comprises the following step:
E) adjusting the conveying speed of substrates in each level of inlet vacuum pre-evacuating chamber, vacuum deposition chamber and each level of outlet vacuum protection chamber to shorten the distance between two adjacent substrates before they arriving at the film deposition device in the vacuum deposition chamber, and to enlarge the distance between two adjacent substrates after they left the vacuum deposition chamber.

3. The method of claim 2, wherein step E further comprises shortening the distance between two adjacent substrates to be less than 1 cm before they arriving the film deposition device in the vacuum deposition chamber.

4. The method of claim 2, wherein step E further comprises operating substrates conveys in the inlet vacuum pre-evacuating chamber, vacuum deposition chamber and outlet vacuum protection chamber independently, and controlling the substrates conveying speed by adjusting the conveying speed of corresponding conveyer.

5. The method of claim 3, wherein step E further comprises operating substrates conveys in the inlet vacuum pre-evacuating chamber, vacuum deposition chamber and outlet vacuum protection chamber independently, and controlling the substrates conveying speed by adjusting the conveying speed of corresponding conveyer.

6. The method of claim 2, wherein step E further comprises keeping the conveying speed of substrates constant in vacuum deposition chamber, installing a catch-up zone at the inlet of vacuum deposition chamber, and speeding up the movement of substrate in the inlet vacuum pre-evacuating chamber to catch up with its preceding substrate in catch-up zone.

7. The method of claim 3, wherein step E further comprises keeping the conveying speed of substrates constant in vacuum deposition chamber, installing a catch-up zone at the inlet of vacuum deposition chamber, and speeding up the movement of substrate in the inlet vacuum pre-evacuating chamber to catch up with its preceding substrate in catch-up zone.

8. The method of claim 6, wherein the method further comprises the following step: installing a separate zone at the outlet of vacuum deposition chamber, and speeding up the movement of substrate in the outlet vacuum protection chamber to separate from its following substrate in the separate zone.

9. The method of claim 7, wherein the method further comprises the following step: installing a separate zone at the outlet of vacuum deposition chamber, and speeding up the movement of substrate in the outlet vacuum protection chamber to separate from its following substrate in the separate zone.

10. A continuous film vacuum deposition apparatus comprising:
a vacuum deposition chamber having a film deposition device, an inlet and a outlet;
a conveyer having transmission belts and wheels;
at least one level of inlet vacuum pre-evacuating chamber having a vacuum pump;
at least one level of outlet vacuum protection chamber having a vacuum pump;
slits;
valves having inlet valves and outlet valves; and
a control device;
wherein
said vacuum deposition chamber is used to deposit film on substrates;
said conveyer is used to convey substrates from outside atmosphere air into said vacuum deposition chamber for film deposition through said inlet vacuum pre-evacuating chamber and from said vacuum deposition chamber into outside atmosphere air through said outlet vacuum protection chamber at a certain speed and interval;
said inlet vacuum pre-evacuating chamber is connected with said inlet of vacuum deposition chamber;
said outlet vacuum protection chamber is connected with said outlet of vacuum deposition chamber;
said slits are located between said inlet vacuum pre-evacuating chamber, said vacuum deposition chamber and said outlet vacuum protection chamber, and are used for connection of chambers and movement of substrates;
said valves are located at the position of each slit and are used for sealing chambers, said valves which located at said inlet of vacuum deposition chamber are inlet valves, while said valves which located at said outlet of vacuum deposition chamber are outlet valves;
said valves are opened when the substrate is passing and closed after the substrate has passed;
at least one of said inlet valves and one of said outlet valves are closed when the substrate is entering into said inlet vacuum pre-evacuating chamber and is leaving said outlet vacuum protection chamber; and
said control device is connected with said valves and is used to control opening and closing of valves.

11. The apparatus of claim 10, wherein substrate conveyers at each inlet vacuum pre-evacuating chamber, vacuum deposition chamber and outlet vacuum protection chamber are operated independently, each conveyer is connected by its own stepping motor and the substrate conveying speed is controlled by stepping motor, the distance between two adjacent substrates is shortened before arriving at the film deposition device in vacuum deposition chamber and enlarged when the film-deposited substrates are leaving the vacuum deposition chamber.

12. The apparatus of claim 10, wherein said substrates are arranged continuously in vacuum deposition chamber, and the distance between two adjacent substrates is less than 1 cm.

13. The apparatus of claim 11, wherein said substrates are arranged continuously in vacuum deposition chamber, and the distance between two adjacent substrates is less than 1 cm.

14. The apparatus of claim 10, wherein said inlet vacuum pre-evacuating chamber and said outlet vacuum protection chamber have two levels, respectively, the first level of said inlet vacuum pre-evacuating chamber is connected with outside atmosphere air and the second level of said inlet vacuum pre-evacuating chamber is connected with said inlet of vacuum deposition chamber. The first level of said outlet vacuum protection chamber is connected with outside atmosphere air and the second level of said outlet vacuum protection chamber is connected with said outlet of vacuum deposition chamber. Once the inlet valve of the first level of said inlet vacuum pre-evacuating chamber connecting with outside atmosphere air is opened for substrate to pass through, the inlet valve between two levels of inlet vacuum pre-evacuating chambers is in off-state. Once the outlet valve of the first level of said outlet vacuum protection chamber connecting with outside atmosphere air is opened for substrate to pass through, the outlet valve between two levels of said outlet vacuum protection chambers is in off-state.

15. The apparatus of claim 11, wherein said inlet vacuum pre-evacuating chamber and said outlet vacuum protection chamber have two levels, respectively, the first level of said inlet vacuum pre-evacuating chamber is connected with outside atmosphere air and the second level of said inlet vacuum pre-evacuating chamber is connected with said inlet of vacuum deposition chamber. The first level of said outlet vacuum protection chamber is connected with outside atmosphere air and the second level of said outlet vacuum protection chamber is connected with said outlet of vacuum deposition chamber. Once the inlet valve of the first level of said inlet vacuum pre-evacuating chamber connecting with outside atmosphere air is opened for substrate to pass through, the inlet valve between two levels of inlet vacuum pre-evacuating chambers is in off-state. Once the outlet valve of the first level of said outlet vacuum protection chamber connecting with outside atmosphere air is opened for substrate to pass through, the outlet valve between two levels of said outlet vacuum protection chambers is in off-state.

16. The apparatus of claim 10, wherein a catch-up zone is installed at said inlet of vacuum deposition chamber and used for substrate to catch up with its preceding substrate; a separate zone is installed at said outlet of vacuum deposition chamber and used for substrate to separate from its following substrates.

17. The apparatus of claim 11, wherein a catch-up zone is installed at said inlet of vacuum deposition chamber and used for substrate to catch up with its preceding substrate; a separate zone is installed at said outlet of vacuum deposition chamber and used for substrate to separate from its following substrates.

18. The apparatus of claim 16, wherein said catch-up zone and separate zone are equipped with balancing wheel instead of transmission wheel to support substrates.

19. The apparatus of claim 17, wherein said catch-up zone and separate zone are equipped with balancing wheel instead of transmission wheel to support substrates.
